(19) United States
(12) Patent Application Publication
(10) Pub. No.: US 2026/0179406 A1
(43) Pub. Date: Jun. 25, 2026

(54) GENERATING VALIDITY CLASSIFICATIONS FOR DIGITAL COMMUNICATIONS UTILIZING A MACHINE LEARNING MODEL

(71) Applicant: Chime Financial, Inc., San Francisco, CA (US)

(72) Inventors: Naomi Yung, Redwood City, CA (US); Lace Cheung, San Francisco, CA (US); Andrew Rodriguez, Hanford, CA (US); Dennis Yang, San Francisco, CA (US); Kevin Shu, Chicago, IL (US); James Sheak, San Mateo, CA (US); Anton Laptiev, Vancouver (CA)

(21) Appl. No.: 18/999,831

(22) Filed: Dec. 23, 2024

(51) Int. Cl. G06V 30/32; G06V 10/764; H04L 9/40

(52) U.S. Cl. CPC G06V 30/36; G06V 10/764; H04L 63/1416

(57) ABSTRACT

The present disclosure relates to systems, non-transitory computer-readable media, and methods for generating validity notifications including validity classifications utilizing a communication validation machine learning model. In particular, in one or more embodiments, the disclosed systems receive a digital image including a digital communication. Further, in some embodiments, the communication validation system utilizes a communication validation machine learning model to analyze the digital image and determine a validity classification. In one or more embodiments, the communication validation system also generates and provides a notification including the validity classification to a client device.

### BACKGROUND

Recent years have seen a significant development in systems that utilize web-based and mobile-based applications to manage user accounts and digital information for user accounts in real time. To illustrate, many conventional systems determine and communicate digital information to user accounts on web-based and mobile-based applications. However, recent years have also seen unfortunate development in fraudulent activity attempting to imitate the appearance of communications from specific institutions. Although conventional systems attempt to dissuade this fraudulent activity with generic warnings, such conventional systems face a number of technical shortcomings, particularly with regard to the flexibility, efficiency, and accuracy in identifying fraudulent activity.

Although conventional systems can provide general warnings of fraudulent activity, such systems have a number of problems in relation to flexibility of operation. For instance, some conventional systems inflexibly monitor account activity for unusual interactions or transactions only within the first-party application or system. However, fraudulent activity often originates outside of applications corresponding to institutions within which the fraud is eventually carried out. For example, fraudulent activity can originate via email, text messaging, or instant messaging on a variety of platforms. The inflexibility of many conventional systems to operate only for existing transactions or interactions on the first-party application or platform causes conventional systems to fail to address these instances of fraudulent activity.

Accordingly, conventional systems often provide inefficient and inaccurate notifications regarding fraudulent activity. Indeed, many conventional systems provide generic warning notifications for all or most transactions. In addition to wasting computing time and resources, these excess notifications are inaccurate because they are general-purpose and not based on any data. These generic warning notifications fail to accurately identify fraudulent activity because they are so extraordinarily over-inclusive.

These along with additional problems and issues exist with regard to conventional systems.

### BRIEF SUMMARY

Embodiments of the present disclosure provide benefits and/or solve one or more of the foregoing or other problems in the art with systems, non-transitory computer-readable media, and methods for utilizing a machine learning model to analyze digital communications and generate validity classifications. More specifically, in one or more embodiments, the disclosed systems can utilize a machine learning model to determine validity classifications for digital communications based on digital images including digital communications. Further, in some embodiments, the disclosed systems generate a notification to a client device associated with the digital communication including an indication of a validity classification as either a genuine communication or a fraudulent communication.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example process for providing a notification including a validity classification in accordance with one or more embodiments.

FIG. 2 illustrates an example process for receiving and utilizing a digital image including a digital communication in accordance with one or more embodiments.

FIG. 3 illustrates an example process for generating a validity classification utilizing a communication validation machine learning model in accordance with one or more embodiments.

FIGS. 4A-4C illustrate example graphical user interfaces indicating an ongoing call in accordance with one or more embodiments,

FIGS. 5A-5B illustrate example graphical user interfaces for communication validation in accordance with one or more embodiments.

FIG. 6 illustrates an example process for training a communication validation machine learning model in accordance with one or more embodiments.

FIG. 7 illustrates a diagram of an environment in which a communication validation system can operate in accordance with one or more embodiments.

FIG. 8 illustrates a flowchart of a series of acts for generating a validity classification in accordance with one or more embodiments.

FIG. 9 illustrates a block diagram of an example computing device for implementing one or more embodiments of the present disclosure.

FIG. 10 illustrates an example environment for an inter-network facilitation system in accordance with one or more implementations.

### DETAILED DESCRIPTION

This disclosure describes one or more embodiments of a communication validation system that utilizes a communication validation machine learning model to generate validity classifications for digital communications. To illustrate, in one or more embodiments, the communication validation system utilizes the validation machine learning model to analyze a digital image of a digital communication and determine a validity classification. Additionally, in some embodiments, the communication validation system can utilize additional data corresponding to the digital communication, such as user data and/or contact information. In some embodiments, the communication validation system can generate and provide a notification indicating a validity classification.

In one or more embodiments, the communication validation system receives user input indicating data corresponding to a digital communication. For example, in some embodiments, the communication validation system receives a user submission or upload of a screenshot or other digital image including a digital communication. Additionally, in one or more embodiments, the communication validation system receives user input indicating contact information corresponding to the digital communication. Further, in some embodiments, the communication validation system receives or accesses user account information such as messaging history or transaction history.

In one or more embodiments, the communication validation system analyzes this data corresponding to the digital communication, including one or more digital images, utilizing a communication validation machine learning model. In some embodiments, the communication validation machine learning model is a binary classification model. More specifically, in one or more embodiments, the communication validation machine learning model is a multimodal binary classification model that analyzes various digital communication data to generate a binary validity classification. Additionally, in one or more embodiments, the communication validation machine learning model includes a generative model that utilizes the digital communication data and/or the validity classification to generate a notification that indicates the validity classification of the digital communication.

To illustrate, in one or more embodiments, the communication validation system utilizes validity classifications that either designate a digital communication as a genuine communication or a fraudulent communication. In addition, or in the alternative, the validity classification can designate a digital communication as originating from a specific institution or as not originating from a specific institution. Accordingly, the communication validation machine learning model can determine one or both of these validity classification types. Further, in one or more embodiments, the communication validation machine learning model generates explanations corresponding to one or more of these validity classifications.

More specifically, in some embodiments, the communication validation system generates a notification to a client device that indicates the validity classification of a submitted digital communication. In some embodiments, the notification includes text indicating the classification, such as “This is a communication from Chime,” or “This message is fraudulent.” Additionally, in one or more embodiments, the communication validation system utilizes the communication validation machine learning model to generate explanatory text as to the validity classification. For example, the communication validation system can generate the notification to include an explanation such as “You can tell that this is a genuine communication because of the email domain,” or “You can tell that this email is fraudulent because a genuine Chime associate will never ask you for a confirmation code sent to your phone.”

Further, in one or more embodiments, the communication validation system utilizes the communication validation machine learning model to generate instructions corresponding to a fraudulent digital communication. For example, the communication validation system can utilize the communication validation machine learning model to generate instructions to follow the process in a genuine communication. In another example, the communication validation system can utilize the communication validation machine learning model to generate instructions to ignore or report a fraudulent communication.

In some embodiments, the communication validation system iteratively trains the communication validation machine learning model to generate validity classifications, explanations, and instructions utilizing ground-truth data. Further, the communication validation system can iteratively update the communication validation machine learning model utilizing additional datasets. Accordingly, the communication validation system can update the communication validation machine learning model based on changing methods of fraudulent communication.

The communication validation system provides many advantages and benefits over conventional systems and methods. For example, by determining validity classifications by utilizing a communication validation machine learning model to analyze digital images of digital communications, the communication validation system improves flexibility relative to conventional systems. To illustrate, by enabling determination of a validity classification utilizing a digital image, the communication validation system can evaluate digital communications on a variety of platforms. Accordingly, the communication validation system can address a wide variety of types and methods of fraudulent activity.

Additionally, the communication validation system improves efficiency and accuracy relative to conventional systems by generating specific, data-based validity classifications for digital communications. To illustrate, by utilizing the communication validation machine learning model to analyze digital images of digital communications, the communication validation system reduces or eliminates excess communication warnings required by conventional systems to warn for every transaction. Further, by utilizing the communication validation machine learning model to analyze communication-specific data, the communication validation system accurately identifies fraudulent activity and generates active validity classifications.

In addition, the communication validation system solves a technical problem that arose in a technical field. Namely, computing platforms that include secure user accounts are often connected, integrated with, or use digital communications to send communications between the platform and devices connected to a user account. Digital communications can be insecure because they can be made to appear to come from a particular origin, when in fact the digital communication comes from another origin. Moreover, the technical field of digital communications inherently has a problem in that a digital communication from a fraudulent source can be technically indistinguishable from a digital communication from a true source. Thus, the communication validation system solves this problem in the field by providing systems whereby a given communication can be analyzed to accurately determine a true origin of the communication.

As illustrated by the foregoing discussion, the present disclosure utilizes a variety of terms to describe features and advantages of the communication validation system. Additional detail is now provided regarding the meaning of such terms. For example, as used herein, the term “digital communication” refers to a digital message corresponding to a client device. In particular, the term digital communication can include an instant message or text message, including a message captured in a screenshot or other digital image. To illustrate, a communication can include an email, an instant message, a text, a support ticket, or a variety of digital communications including text.

Further, as used herein, the term “digital image” refers to an electronic depiction of visual information. In particular, the term digital image can include a variety of electronic image types, including a .jpg file, a .png file, a .pdf file, a .tiff file, or a variety of file types. In one or more embodiments, a digital image includes a screenshot of a digital communication such as an email or text message.

Additionally, as used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

Additionally, as used herein, the term “validity classification” refers to an indication of a categorization of authenticity, genuineness, and/or correctness. In particular, the term validity classification can include a classification of either fraudulent or genuine. In addition, or in the alternative, a validity classification can include a certification of actually having originated from a specific institution, or as not having originated from the specific institution.

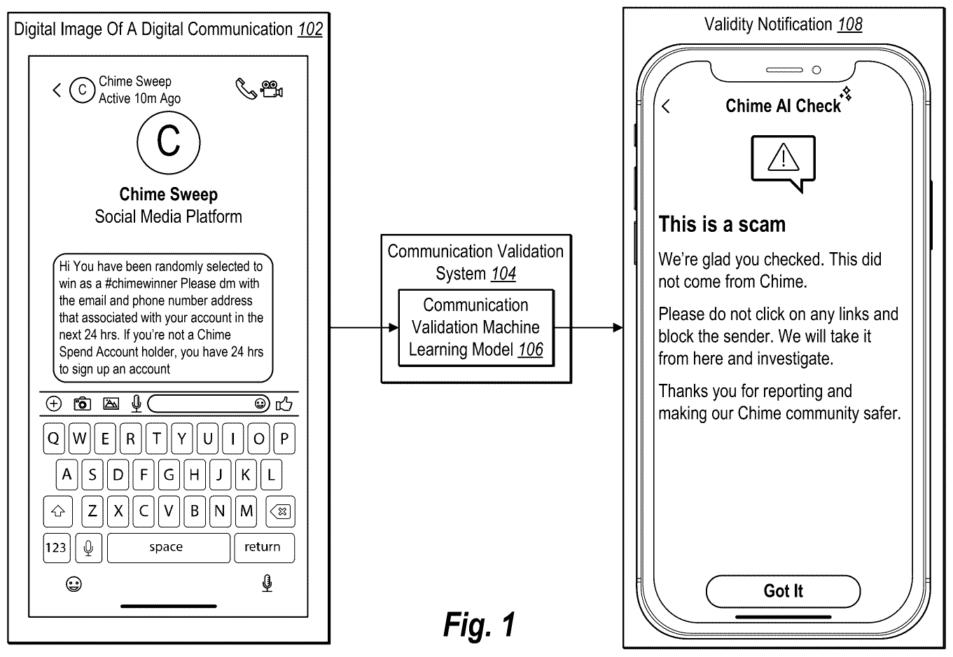

Additional detail will now be provided in relation to illustrative figures portraying example embodiments and implementations of the persona group system. For example, FIG. 1 illustrates an overview of a process for generating and presenting a digital validity notification. More specifically, as shown in FIG. 1, the communication validation system 104 can analyze a digital image of a digital communication 102.

As shown in FIG. 1, the communication validation system 104 receives the digital image of a digital communication 102. In one or more embodiments, the communication validation system 104 receives the digital image of a digital communication 102 from a client device, including via an application. In some embodiments, the digital image of a digital communication 102 is a screenshot of a communication such as an email, text, or instant message.

As also shown in FIG. 1, the communication validation system 104 utilizes a communication validation machine learning model to analyze the digital image of a digital communication 102. In one or more embodiments, the communication validation machine learning model 106 includes a binary classification model. Accordingly, in some embodiments, the communication validation machine learning model 106 determines binary classifications for the digital image of a digital communication 102. Additionally, or in the alternative, in one or more embodiments, the communication validation machine learning model 106 includes a generative model that utilizes the digital image of a digital communication 102 to generate text, such as notification text, instructions, and/or explanations.

Further, in one or more embodiments, the communication validation machine learning model 106 includes a multimodal model. Thus, in some embodiments, the communication validation machine learning model 106 utilizes various data including different data types. For example, the communication validation machine learning model 106 can utilize image data, user demographic data, user interaction history, contact information, and other information. Thus, in some embodiments, the communication validation machine learning model 106 utilizes multimodal data to determine classifications, generate notifications, generate explanations, and/or generate instructions.

Accordingly, as shown in FIG. 1, the communication validation system 104 utilizes the communication validation machine learning model to analyze the digital image of a digital communication 102 and generate the validity notification 108. As shown in FIG. 1, the validity notification 108 includes a warning graphic and the text “This is a scam. We're glad you checked. This did not come from Chime. Please do not click on any links and block the sender. We will take it from here and investigate. Thank you for reporting and making our community safer.” In one or more embodiments, the validity notification is a digital message including text and/or graphics indicating a validity status of the digital image of a digital communication 102.

As shown in FIG. 1, the communication validation system 104 can generate the validity notification including instructions for managing or handling the digital communication depicted in the digital image of a digital communication 102. In one or more embodiments, the communication validation system 104 generates these instructions utilizing the communication validation machine learning model. In addition, or in the alternative, the communication validation system 104 can generate these instructions based on the determined validity status. For example, the communication validation system 104 can utilize a rules-based model to generate instructions for the validity notification 108.

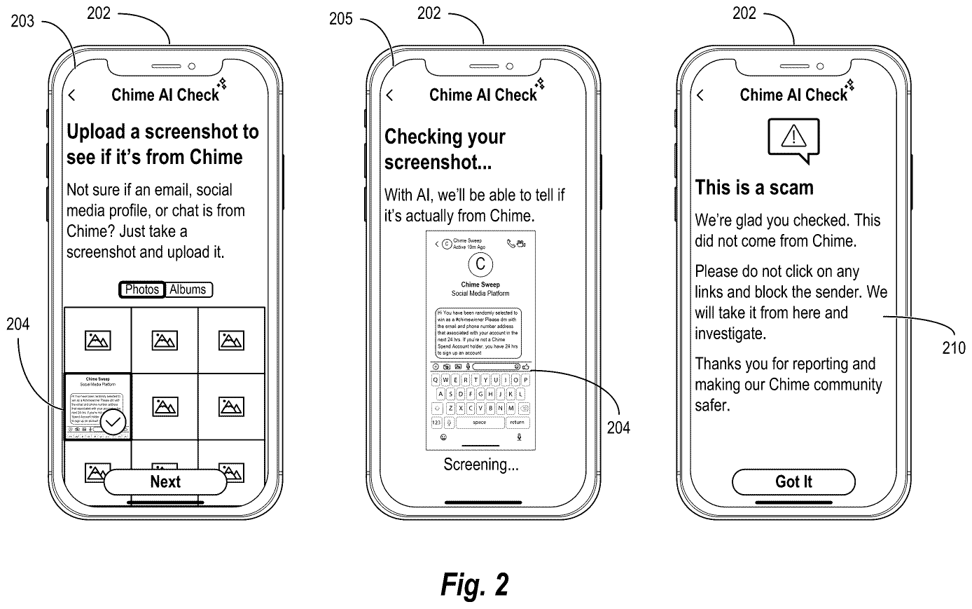

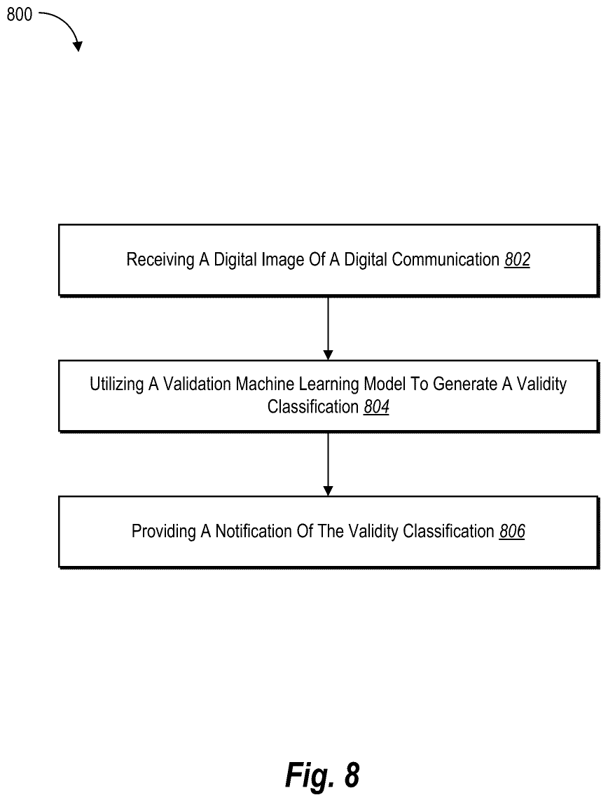

As mentioned above, in one or more embodiments, the communication validation system 104 receives a digital image of a digital communication from a client device. FIG. 2 provides additional detail for an example process of receiving and analyzing a digital image of a digital communication. More specifically, FIG. 2 illustrates graphical user interfaces for receiving user input indicating a digital image for analysis via a native or web application. However, as noted below with regard to FIGS. 8-10, the communication validation system 104 can utilize a variety of device and application types.

As shown in FIG. 2, the communication validation system 104 can receive user input from a client device 202 via a graphical user interface. More specifically, the communication validation system 104 provides a graphical user interface 203 including a title “Chime AI Check” and accompanying text reading “Upload a screenshot to see if it's from Chime. Not sure if an email, social media profile, or chat is from Chime? Just take a screenshot and upload it.” The communication validation system 104 can also access photos from the client device 202 and provide them via the graphical user interface 203.

In one or more embodiments, the digital image of a digital communication 204 is a screenshot of a digital communication, including an instant message, an email, and/or a text message. In one or more embodiments, the digital image of a digital communication 204 includes contact information such as a phone number, an email address, and/or a username. Additionally, in some embodiments, the digital image of a digital communication 204 includes names, logos, signatures, or other indicators of origin.

Further in one or more embodiments, the communication validation system 104 generates and provides the graphical user interface 203 including a variety of photos accessed via the client device 202. Further, the communication validation system 104 can generate and provide the graphical user interface 203 including a variety of titles and/or text that indicate or instruct selection of a digital image including a digital communication. Thus, the communication validation system 104 can receive user indication of a digital image including the digital communication via the client device 202.

In one or more embodiments, the communication validation system 104 can limit the number of submissions of digital images including digital communications. More specifically, the communication validation system 104 can limit the number of submissions allowed by the same user account and/or user device in a specific time period. Accordingly, the communication validation system 104 can avoid misuse of the tool, including misuse for fraudulent data collection.

Accordingly, as shown in FIG. 2, the communication validation system 104 receives user input indicating selection of a digital image of a digital communication 204. Based on receiving this user input, the communication validation system 104 can provide a visual indicator that the digital image of the digital communication was selected. Further, based on additional user interaction confirming the selection of the digital image of a digital communication 204, the communication validation system 104 can provide an image check graphical user interface 205.

As shown in FIG. 2, the communication validation system 104 generates the image check graphical user interface 205 including the text “Checking your screenshot . . . With AI, we'll be able to tell if it's actually from Chime.” As also shown in FIG. 2, the communication validation system 104 includes a depiction of the digital image of a digital communication 204 with an overlay to indicate that the communication validation system 104 is analyzing the digital image of a digital communication 204. In one or more embodiments, the communication validation system 104 can provide the image check graphical user interface 205 during the time in which the communication validation machine learning model analyzes the digital image of a digital communication 204.

Further, the communication validation system 104 can including a variety of text or overlays indicating analysis of the digital image of a digital communication 204. Similarly, the communication validation system 104 can generate the image check graphical user interface 205 including a variety of explanations or text that convey that analysis is ongoing. Additionally, though FIG. 2 shows the image check graphical user interface 205 including the digital image of a digital communication 204, the communication validation system 104 can generate the image check graphical user interface 205 without the digital image of a digital communication 204.

In addition, or in the alternative to receiving the digital image of a digital communication 204 via user submission on an application, the communication validation system 104 can receive the digital image of a digital communication 204 via user posts on digital forums. To illustrate, in one or more embodiments, the communication validation system 104 can deploy an autonomous or semi-autonomous user account on a digital forum that can detect and respond to user posts inquiring about fraud on a relevant platform. For example, the communication validation system 104 can utilize the automated user account to monitor one or more digital forums for posts inquiring about fraudulent messages.

Further, the communication validation system 104 can utilize the automated user account to identify a digital image including a digital communication from the posts inquiring about fraudulent messages. Accordingly, the communication validation system 104 can then analyze the digital images including digital communications from user-generated posts in online forums and determine validity classifications, instructions, and/or explanations. Further, the communication validation system 104 can utilize the automated user account to post, comment, message, or take other action to provide the validity classifications, instructions, and/or explanations to user accounts that post these posts inquiring about fraudulent messages.

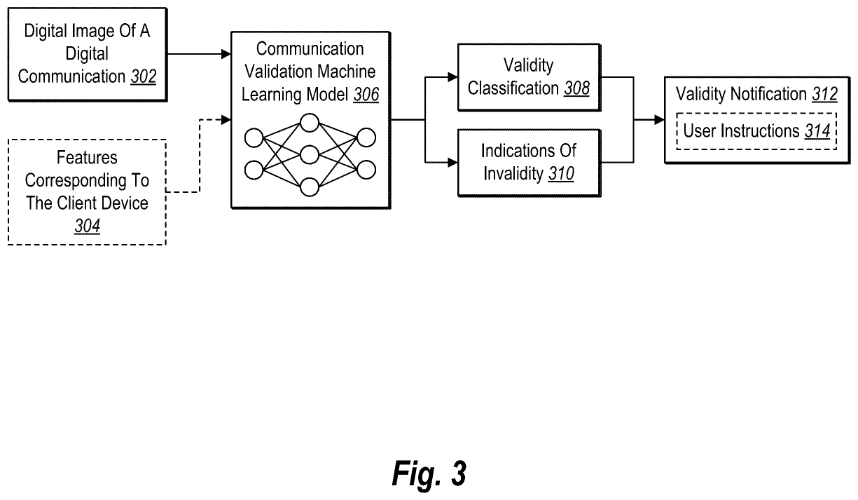

As mentioned above, the communication validation system 104 generates a notification based on the digital image of a digital communication 204. As shown in FIG. 2, the communication validation system 104 provides a validity notification 210 to the client device 202 based on the digital image of a digital communication 204. More specifically, the validity notification 210 includes a warning graphic and the text “This is a scam. We're glad you checked. This did not come from Chime. Please do not click on any links and block the sender. We will take it from here and investigate. Thank you for reporting and making our community safer.” As mentioned above, and as will be discussed in greater detail below with regard to FIG. 3, the communication validation system 104 can utilize a communication validation machine learning model to generate the validity notification 210 including a variety of validity classifications, explanations, and/or instructions.

FIG. 3 provides additional detail for an example process for the communication validation system 104 generating validity classifications, indications of invalidity, and/or user instructions. To illustrate, as shown in FIG. 3, the communication validation system 104 inputs a digital image of a digital communication 302 into a communication validation machine learning model 306. As mentioned above, in one or more embodiments, the digital image of the digital communication can include a screenshot of a digital communication from a client device.

As also shown in FIG. 3, the communication validation system 104 can optionally provide additional features corresponding to the client device 304. In one or more embodiments, the features corresponding to the client device 304 include user activity, such as transaction history, user communication history, user account type, user demographic information, and other user or account features. In some embodiments, the communication validation system 104 extracts the features corresponding to the client device 304 in response to user submission of the digital image of a digital communication 302.

Additionally, as shown in FIG. 3, the communication validation machine learning model 306 analyzes the digital image of the digital communication 302 and the features corresponding to the client device 304. Accordingly, the communication validation machine learning model 306 generates a validity classification 308 based on the digital image of the digital communication 302 and the features corresponding to the client device 304. In one or more embodiments, the validity classification 308 categorizes the digital communication as either a genuine communication or a fraudulent communication. For example, a genuine communication could include a payment reminder from a utility company, a password change link from a banking institution, a notification that a direct deposit has been received, or a variety of other communication types that do not pose a threat of fraud or theft. For a validity classification as a fraudulent communication, the digital communication could include a phishing email requesting personal information, a text including a malware link, an instant message illegitimately requesting a wire transfer of funds, or a variety of other communication types that indicate a risk of theft or fraud.

In addition, or in the alternative, the communication validation machine learning model 306 can generate a validity classification 308 that indicates a certification that the digital communication either did or did not originate from a specific institution. To illustrate, the communication validation machine learning model 306 can determine whether a communication actually originated from the sender that it proports to have been sent from. Accordingly, a validity classification of from a specific institution indicates that the corresponding digital message was actually sent by the institution indicated by the text, logos, and/or signatures included in the digital message. Further, a validity classification of not from a specific institution indicates that the corresponding digital message was sent by a sender other than the institution indicated by the text, logos, and/or signatures included in the digital message.

As also shown in FIG. 3, the communication validation machine learning model 306 can generate indications of invalidity 310. Indeed, in one or more embodiments, the communication validation machine learning model identifies one or more portions of the digital image of a digital communication 302 that indicate that a message is not genuine. For example, the communication validation machine learning model 306 generates a determination that the contact information in the message does not match valid contact information for an institution indicated by the digital message. In another example, the communication validation machine learning model 306 generates a determination that the digital image of a digital communication 302 includes a logo that is incorrect or out-of-date. For an additional example, the communication validation machine learning model 306 generates a determination that the text of the digital message is indicative of a method of fraud.

Accordingly, as shown in FIG. 3, the communication validation system 104 can utilize the validity classification 308 and/or the indications of invalidity 310 to generate a validity notification 312. For example, the communication validation system 104 can generate text indicating the validity classification 308. Further, the communication validation system 104 can generate explanations of invalidity based on the indications of invalidity 310. For example, for a fraudulent validity classification 308 and indications of invalidity 310 including a fraudulent request and non-matching contact information, the communication validation system 104 can generate a validity notification 312 including the text “This email is fraudulent and did not come from us. This email came from a different email domain and the phone number that the email requests you to call is not a genuine Chime phone number.”

As also shown in FIG. 3, the communication validation system 104 can optionally generate the validity notification 312 to include user instructions 314. In one or more embodiments, the communication validation machine learning model 306 can generate the user instructions 314 based on the digital image of the digital communication 302. In addition, or in the alternative, the communication validation system 104 can utilize a rules-based model to generate the user instructions 314 based on the validity classification 308.

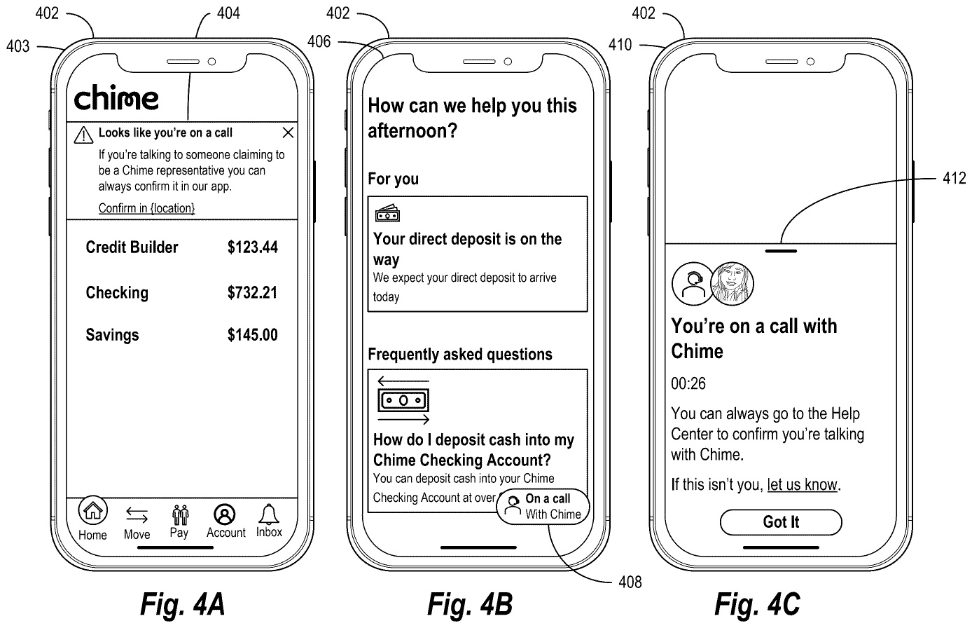

In addition to analyzing and explaining digital images of digital communications, the communication validation system 104 can provide additional information about ongoing communications with an institution. For example, the communication validation system 104 can monitor ongoing calls with an institution, and can report the ongoing calls via an application on a client device. FIGS. 4A-4C illustrate example graphical user interfaces for reporting ongoing calls.

In one or more embodiments, the communication validation system 104 receives call information from an inter-network facilitation system or another system that manages communication for an institution. Based on determining that there is an active call, the communication validation system 104 can identify a user account associated with the phone number on the active call. Further, in one or more embodiments, the communication validation system 104 provides an indication of the ongoing call in an application, webpage, or other location on a client device associated with the user account.

To illustrate, FIG. 4A shows a client device 402 displaying a graphical user interface 403. In this example, the communication validation system 104 determines that there is an ongoing call between the institution corresponding to the application and a phone number corresponding to the user account for the client device 402. Based on this determination, the communication validation system 104 generates the graphical user interface 403 including an overlay 404. The overlay 404 covers the top portion of the graphical user interface 403. Additionally, as shown in FIG. 4A, the overlay 404 includes the text “Looks like you're on a call. If you're talking to someone claiming to be a Chime representative, you can always confirm it in our app.” The overlay 404 also includes a link to a page on the application where the communication validation system 104 can receive additional communication for validation.

In one or more embodiments, the client device 402 can send a notification message to the communication validation system 104 (e.g., via device application 707) indicating the client device is in an active phone call. The communication validation system can then query the agent call system within the inter-network facilitation system 704 to determine if the agent call system has logged a current call with the phone number associated with client device 402. Based on determining the agent call system has logged a current call with the phone number associated with the client device, the communication validation system 104 can generate and provide a communication validation notification for display within the graphical user interface 403 that confirms the client device is on a call with the agent call system associated with the inter-network facilitation system.

In one or more embodiments, the communication validation system 104 determines that the agent call system does not have a current call logged for the phone number associated with the client device 402. In such a case, the communication validation system 104 can generate and provide a communication warning notification for display within the graphical user interface 403. For example, the communication warning notification can indicate a confirmation that the client device is not on a call with Chime. In addition to generating a notification, the communication validation system 104 can limit or block features within the application based on detecting the client device 104 is participating in an active call that and that the active call is not logged in as a current call within the call agent system. For example, the communication validation system 104 can block peer-to-peer transactions in this situation since often times when a user is on the phone and while accessing the peer-to-peer transaction feature, the user may be being coached in a fraudulent scheme to transfer money to a fraudster's account.

The communication validation system 104 can generate and provide a variety of graphical user interface elements that indicate that a call is ongoing with a genuine representative of a specific institution. In another example, FIG. 4B illustrates the client device 402 displaying a graphical user interface 406. More specifically, the communication validation system 104 generates the graphical user interface 406 to include an overlay 408 that indicates “On a call with Chime.” The overlay 408 is a small oval icon that covers the lower right-hand corner of the graphical user interface 406.

In another example, the communication validation system 104 can generate and provide a larger indication of an ongoing call. FIG. 4C illustrates the client device 402 displaying a graphical user interface 410 including an ongoing call page 412. The ongoing call page takes up the lower half of the screen and reads “You're on a call with Chime. You can always go to the Help Center to confirm you're talking with Chime. If this isn't you, let us know.” The ongoing call page 412 also includes the call duration and a link to a page where a user can report that the ongoing call is fraudulent.

Accordingly, the communication validation system 104 can validate ongoing calls by reporting call information within an application. In one or more embodiments, the communication validation system 104 can generate a variety of graphical user interface elements that include call information. Further, the communication validation system 104 can remove these graphical user interface elements in response to determining that the call has ended.

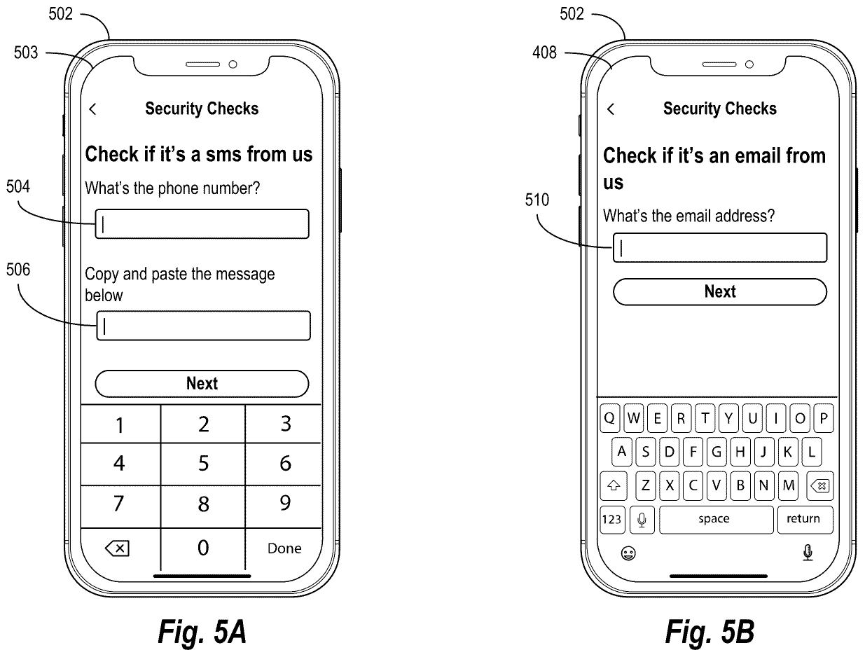

In one or more embodiments, the communication validation system 104 can also utilize a communication validation machine learning model to analyze communication data provided in a text format. FIGS. 5A-45 illustrate graphical user interfaces for collecting such data. However, similar to the discussion above with regard to FIG. 1, in one or more embodiments, the communication validation system 104 can limit the number of submissions accepted from a particular user account in a given time period.

FIG. 5A shows a client device 502 displaying a graphical user interface 503. The communication validation system 104 generates the graphical user interface 503 including the text, “Check if it's a SMS from us.” Additionally, the graphical user interface includes a data entry element 504 under the text, “What's the phone number?” and a data entry element 506 under the text, “Copy and paste the message below.”

In one or more embodiments, the communication validation system 104 can utilize a communication validation machine learning model to analyze the phone number and the body of the text received via the graphical user interface 503. Accordingly, in one or more embodiments, the communication validation system 104 utilizes this communication data to generate validity classifications, validity notifications, indications of invalidity, explanations, and/or instructions. Similarly, the communication validation system 104 can utilize communication data for other communication types, such as email or instant message.

To illustrate, as shown in FIG. 5B, the client device 502 can display a graphical user interface 508 including the text “Check if it's an email from us.” Additionally, the communication validation system 104 generates the graphical user interface 508 to include a data entry element 510 under the text “What is the email address?” The communication validation system 104 can utilize a communication validation machine learning model to analyze the email address received via the graphical user interface 508.

In addition, or in the alternative, the communication validation system 104 can utilize a rules-based algorithm to analyze the communication information received via the graphical user interfaces 503, 508. For example, the communication validation system 104 can generate a validity classification by comparing the received contact information against a log or list of valid contact information corresponding to a specific institution. Based on determining that the contact information corresponding to the digital message is an email address corresponding to the specific institution, the communication validation system 104 can assign a genuine validity classification. However, based on determining that the contact information corresponding to the digital message is not an email address corresponding to the specific institution, the communication validation system 104 can assign a fraudulent validity classification.

In another example, the communication validation system 104 can compare the body of a message to templates utilized by the specific institution. To illustrate, based on determining that the format or template of the digital message is a format or template utilized by the specific institution, the communication validation system 104 can assign a genuine validity classification. However, based on determining that the format or template of the digital message is not a format or template utilized by the specific institution, the communication validation system 104 can assign a fraudulent validity classification.

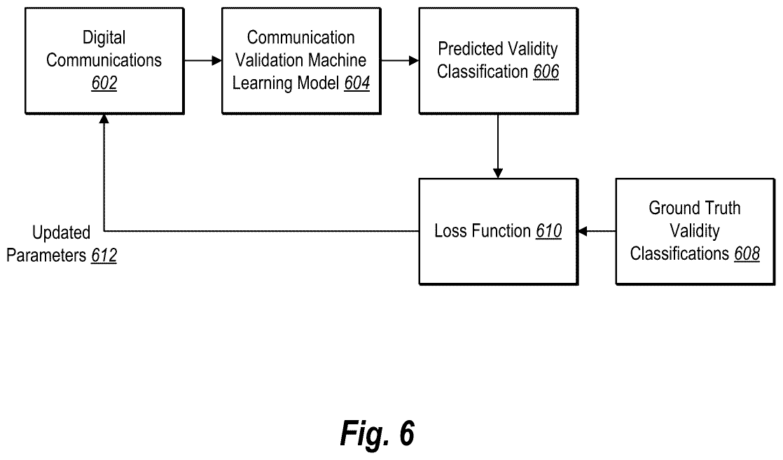

Additionally, in one or more embodiments, the communication validation system 104 trains the communication validation machine learning model. FIG. 6 illustrates an overview of the process of training a communication validation machine learning model. To illustrate, as shown in FIG. 6, the communication validation system 104 training digital communications 602 to the communication validation machine learning model 605.

As also shown in FIG. 6, the communication validation machine learning model 604 generates predicted validity classifications 606. Similar to discussion above, the predicted validity classifications 606 can include classifications as genuine or fraudulent and/or classifications as certified to be from a specific institution or not from a specific institution. Further, as shown in FIG. 5, the communication validation system 104 compares the predicted validity classifications 606 and ground-truth validity classifications 608 utilizing a loss function 610.

Based on the loss from the loss function 610, the communication validation system 104 determines updated parameters 612 for the communication validation machine learning model 604. For example, the communication validation system 104 can utilize back propagation and gradient descent to modify parameters of the communication validation machine learning model 604. Accordingly, the communication validation system 104 can iteratively train the communication validation machine learning model 604 to generate accurate validity classifications by performing additional training iterations until the loss from the loss function 610 is sufficiently minimized.

In addition, or in the alternative, in one or more embodiments, the communication validation system 104 further trains the communication validation machine learning model 604 to generate accurate ground-truth explanations and/or instructions utilizing ground-truth explanations and/or instructions. To illustrate, the communication validation machine learning model 604 generates predicted explanations and/or instructions. Further, similar to discussion above, the communication validation system 104 compares the predicted explanations and/or instructions and ground-truth explanations and/or instructions utilizing the loss function 610.

Similarly, as discussed above, in one or more embodiments, the communication validation system 104 can train the communication validation machine learning model 604 to utilize additional communication data. Accordingly, in one or more embodiments, in addition to providing a training set of digital communications 602, the communication validation system 104 can utilize additional training data in the training dataset including user data, communication records, image metadata, and other information. More specifically, in one or more embodiments, the communication validation system 104 can further utilize contact information such as email addresses or phone numbers to train the communication validation machine learning model 604.

Further, in one or more embodiments, the communication validation machine learning model can continually update the training of the communication validation machine learning model 604 utilizing additional ground-truth data. More specifically, the communication validation system 104 can generate a dataset of new or updated digital communications (including digital images of digital communications) and corresponding ground-truth data to update the training of the communication validation machine learning model 604. Thus, the communication validation machine learning model can run additional iterations to update the communication validation machine learning model 604 by performing additional training iterations until the loss from the loss function 610 is sufficiently minimized on the updated training data.

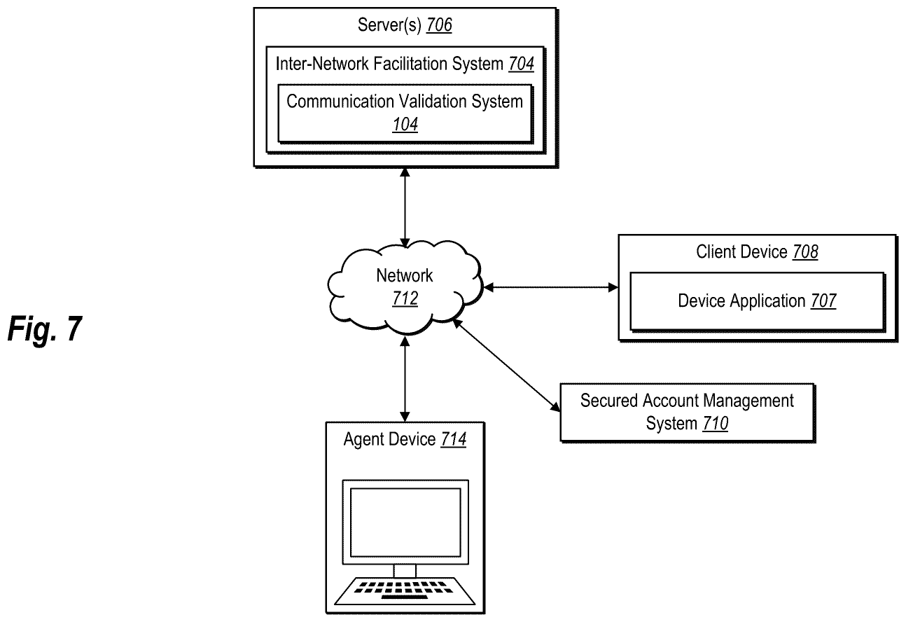

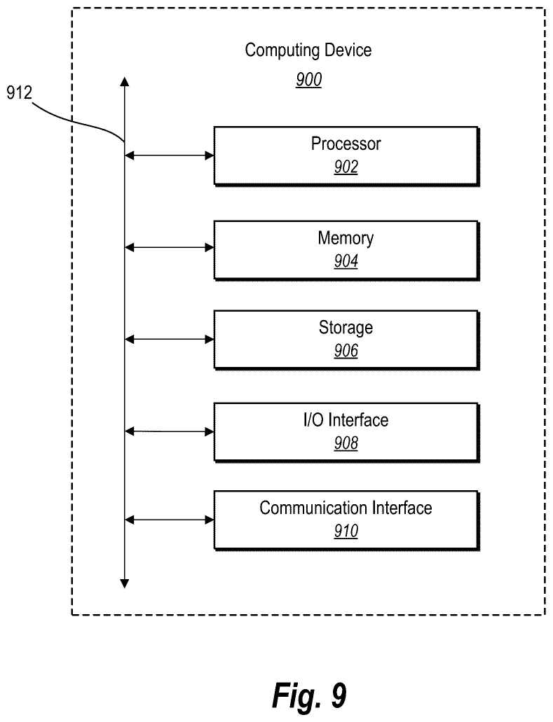

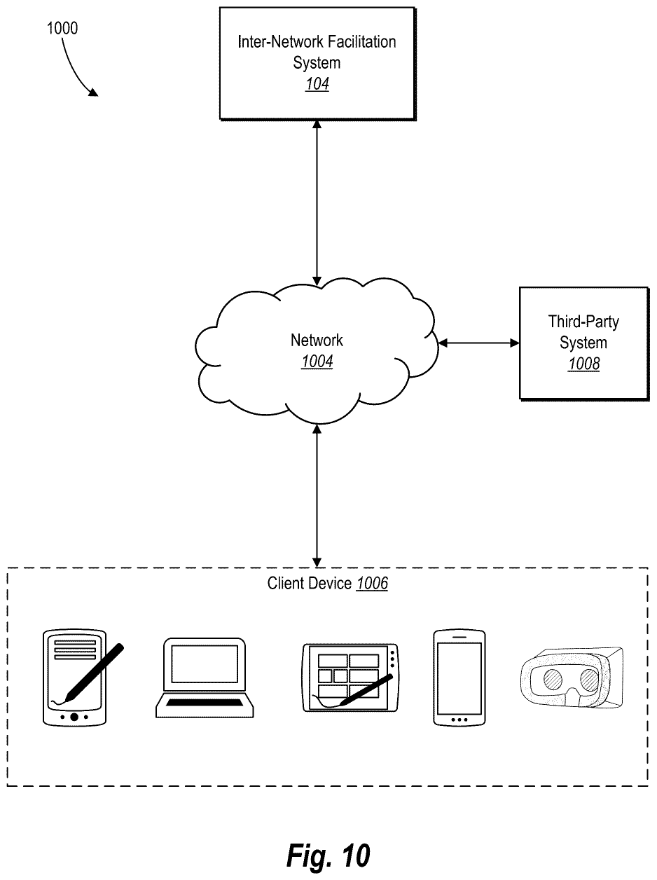

FIG. 7 illustrates a block diagram of a system environment for implementing the communication validation system 104 in accordance with one or more embodiments. As shown in FIG. 7, the environment includes server(s) 706 implementing the communication validation system 104 part of an inter-network facilitation system 704. The environment of FIG. 7 further includes a client device 708, a device application 709, an agent device 714, and a secured account management system 710. The server(s) 706 can include one or more computing devices to implement the communication validation system 104. Additional description regarding the illustrated computing devices (e.g., the server(s) 706, the client device 708, the agent device 714 and/or the secured account management system 710) is provided with respect to FIGS. 9-10 below.

As shown, the communication validation system 104 utilizes the network 712 to communicate with the client device 708, the agent device 714, and/or the secured account management system 710. The network 712 may comprise a network as described in relation to FIGS. 9-10. For example, the communication validation system 104 communicates with the client device 708 to provide validity notifications, including validity classifications and/or to receive digital communication data, including digital images. Indeed, the inter-network facilitation system 704 or the communication validation system 104 can provide validity notifications to the client device 708 or can facilitate a session between the agent device 714 and the client device 708.

As described in greater detail below (e.g., in relation to FIG. 10), the inter-network facilitation system 704 can manage interactions across multiple devices, providers, and computer systems. For example, the inter-network facilitation system 704 can execute transactions across various third-party systems such as a banking entities, automated transaction machines, or payment providers. The inter-network facilitation system 704 can also maintain and manage digital accounts for client devices/users to store, manage, and/or transfer funds to other users.

To facilitate generating validity classifications, instructions, and/or explanations, in some embodiments, the inter-network facilitation system 704 or the communication validation system 104 communicates with the secured account management system 710. More specifically, the inter-network facilitation system 704 or the communication validation system 104 determines the identity and permissions of the client device 708 by communicating with the secured account management system 710. The communication validation system 104 can determine permissions of the client device 708 prior to disclosing secure information to the client device 708. For example, the inter-network facilitation system 704 or the communication validation system 104 accesses a secured account maintained by the secured account management system 710 (e.g., remotely from the server(s) 706).

In one or more embodiments, the inter-network facilitation system 704 or the communication validation system 104 communicates with the secured account management system 710 in response to the communication validation system 104 receiving data (e.g., a communication and corresponding account data) from the client device 708. In particular, the inter-network facilitation system 704 or the communication validation system 104 provides an indication of a secured account associated with a digital account to indicate that the client device 708 is authorized to receive information pertaining to the digital account. In addition, the inter-network facilitation system 704 or the communication validation system 104 communicates with the secured account management system 710 to determine permissions and/or activity of the client device 708. For example, the inter-network facilitation system 704 or the communication validation system 104 provide information to the client device 708 such as direct deposit status, digital account updates, device fee information, check status, interaction history, order status, activation, etc.

As indicated by FIG. 7, the client device 708 includes the device application 709. In particular, the device application 709 can include a web application, a native application installed on the client device 708 (e.g., a mobile application, a desktop application, etc.), or a cloud-based application where all or part of the functionality is performed by the server(s) 706. In some embodiments, the inter-network facilitation system 704 or the communication validation system 104 communicates with the client device 708 through the device application 709. This communication for example, receives and provides information including digital communication data, digital images, validity classifications, validity notifications, direct deposit status, digital account updates, device fee information, check status, interaction history, order status, activation, etc. Additionally, the communication validation system 104 can provide digital account information and secured account information for display within a graphical user interface associated with the device application 709 or can provide digital account information via other methods.

As shown in FIG. 1, the client device 708 implements the device application 709 in conjunction with interaction with the inter-network facilitation system 704 or the communication validation system 104. For example, the inter-network facilitation system 704 or the communication validation system 104 can monitor the activities of the device application 709. In particular, these activities can include events such as communications on the application 709, ongoing calls associated with the user account, time spent on device application 709, recently viewed pages on device application 709, the most recent activation activity of the device application 709, etc.

Although FIG. 7 illustrates the environment having a particular number and arrangement of components associated with the communication validation system 104, in some embodiments, the environment may include more or fewer components with varying configurations. For example, in some embodiments, the inter-network facilitation system 704 or the communication validation system 104 can communicate directly with the client device 708, device application 709, and/or the secured account management system 710, bypassing the network 712. In these or other embodiments, the inter-network facilitation system 704 or the communication validation system 104 can be implemented (entirely on in part) on the client device 708. Additionally, the inter-network facilitation system 704 or the communication validation system 104 can include or communicate with a database for storing information, such as direct deposit status, digital account updates, device fee information, check status, interaction history, order status, activation, and/or other information described herein.

FIGS. 1-7, the corresponding text, and the examples provide a number of different methods, systems, devices, and non-transitory computer-readable media of the communication validation system. In addition to the foregoing, one or more embodiments can also be described in terms of flowcharts comprising acts for accomplishing a particular result, as shown in FIG. [symbol] . FIG. [symbol] may be performed with more or fewer acts. Further, the acts may be performed in differing orders. Additionally, the acts described herein may be repeated or performed in parallel with one another or parallel with different instances of the same or similar acts.

As mentioned, FIG. 8 illustrates a flowchart of a series of acts 800 for generating and providing a validity classification in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, the series of acts 800 includes an act 802 for receiving a digital image of a digital communication. More specifically, the act 802 can include receiving, via a client device, a digital image comprising a digital communication.

In addition, the series of acts 800 includes an act 804 for utilizing a validation machine learning model to generate a validity classification. More specifically, the act 804 can include utilizing a communication validation machine learning model to analyze the digital communication and generate a validity classification for the digital communication.

Further, the series of acts 800 includes an act 806 for providing a notification of the validity classification. More specifically, the act 806 can include providing a notification to the client device indicating the validity classification.

Additionally, in one or more embodiments, the series of acts 800 can include wherein the validity classification indicates a categorization of genuine communication or fraudulent communication. In some embodiments, the series of acts also includes wherein the validity classification indicates a certification that the digital communication originated from a specific institution.

Further, the series of acts 800 can include utilizing the communication validation machine learning model to determine one or more indications of invalidity in the digital image, generating instructions for addressing the digital communication based on the digital image, and providing the one or more indications of invalidity and the instructions for addressing the digital communication in the notification to the client device.

In some embodiments, the series of acts 800 also includes extracting one or more user features corresponding to the client device, and utilizing the communication validation machine learning model to further analyze the one or more user features to determine the validity classification of the digital communication. Additionally, in one or more embodiments, the series of acts 800 includes receiving user input indicating a phone number associated with the digital communication or an email address associated with the digital communication, and utilizing the communication validation machine learning model to further analyze the phone number associated with the digital communication or the email address associated with the digital communication to determine the validity classification of the digital communication.

Also, in one or more embodiments, the series of acts 800 includes iteratively training the communication validation machine learning model to utilizing a loss function and a ground-truth dataset of digital images of communications and corresponding ground-truth validity classifications.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the server(s) 706, the client device 708, and/or the administrator device 714) that may be configured to perform one or more of the processes described above. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. The I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the inter-network facilitation system 704. The network environment 1000 includes a client device 1006 (e.g., client device 708, agent device 714), an inter-network facilitation system 704, and a third-party system 1008 connected to each other by a network 1004. Although FIG. 10 illustrates a particular arrangement of the client device 1006, the inter-network facilitation system 704, the third-party system 1008, and the network 1004, this disclosure contemplates any suitable arrangement of client device 1006, the inter-network facilitation system 704, the third-party system 1008, and the network 1004. As an example, and not by way of limitation, two or more of client device 1006, the inter-network facilitation system 704, and the third-party system 1008 communicate directly, bypassing network 1004. As another example, two or more of client device 1006, the inter-network facilitation system 704, and the third-party system 1008 may be physically or logically co-located with each other in whole or in part.

Moreover, although FIG. 10 illustrates a particular number of client devices 1006, inter-network facilitation systems 704, third-party systems 1008, and networks 1004, this disclosure contemplates any suitable number of client devices 1006, inter-network facilitation system 704, third-party systems 1008, and networks 1004. As an example, and not by way of limitation, network environment 1000 may include multiple client devices 1006, inter-network facilitation system 704, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks.

Links may connect client device 1006, communication validation system 104, and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 704 may be a network-addressable computing system that can interface between two or more computing networks or servers associated with different entities such as financial institutions (e.g., banks, credit processing systems, ATM systems, or others). In particular, the inter-network facilitation system 704 can send and receive network communications (e.g., via the network 1004) to link the third-party-system 1008. For example, the inter-network facilitation system 704 may receive authentication credentials from a user to link a third-party system 1008 such as an online bank account, credit account, debit account, or other financial account to a user account within the inter-network facilitation system 704. The inter-network facilitation system 704 can subsequently communicate with the third-party system 1008 to detect or identify balances, transactions, withdrawal, transfers, deposits, credits, debits, or other transaction types associated with the third-party system 1008. The inter-network facilitation system 704 can further provide the aforementioned or other financial information associated with the third-party system 1008 for display via the client device 1006. In some cases, the inter-network facilitation system 704 links more than one third-party system 1008, receiving account information for accounts associated with each respective third-party system 1008 and performing operations or transactions between the different systems via authorized network connections.

In particular embodiments, the inter-network facilitation system 704 may interface between an online banking system and a credit processing system via the network 1004. For example, the inter-network facilitation system 704 can provide access to a bank account of a third-party system 1008 and linked to a user account within the inter-network facilitation system 704. Indeed, the inter-network facilitation system 704 can facilitate access to, and transactions to and from, the bank account of the third-party system 1008 via a client application of the inter-network facilitation system 704 on the client device 1006. The inter-network facilitation system 704 can also communicate with a credit processing system, an ATM system, and/or other financial systems (e.g., via the network 1004) to authorize and process credit charges to a credit account, perform ATM transactions, perform transfers (or other transactions) across accounts of different third-party systems 1008, and to present corresponding information via the client device 1006.

In particular embodiments, the inter-network facilitation system 704 includes a model for approving or denying transactions. For example, the inter-network facilitation system 704 includes an acceptance probability machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 704 and/or one or more third-party systems 1008), the inter-network facilitation system 704 can utilize the acceptance approval machine learning model to generate a prediction (e.g., a percentage likelihood) of approval or denial of a transaction (e.g., a deposit, a withdrawal, a transfer, or a purchase) across one or more networked systems.

The inter-network facilitation system 704 may be accessed by the other components of network environment 1000 either directly or via network 1004. In particular embodiments, the inter-network facilitation system 704 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 704 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 704 to manage, retrieve, modify, add, or delete, the information stored in data store.

In particular embodiments, the inter-network facilitation system 704 may provide users with the ability to take actions on various types of items or objects, supported by the inter-network facilitation system 704. As an example, and not by way of limitation, the items and objects may include financial institution networks for banking, credit processing, or other transactions, to which users of the inter-network facilitation system 704 may belong, computer-based applications that a user may use, transactions, interactions that a user may perform, or other suitable items or objects. A user may interact with anything that is capable of being represented in the inter-network facilitation system 704 or by an external system of a third-party system, which is separate from inter-network facilitation system 704 and coupled to the inter-network facilitation system 704 via a network 1004.

In particular embodiments, the inter-network facilitation system 704 may be capable of linking a variety of entities. As an example, and not by way of limitation, the inter-network facilitation system 704 may enable users to interact with each other or other entities, or to allow users to interact with these entities through an application programming interfaces (“API”) or other communication channels.

In particular embodiments, the inter-network facilitation system 704 may include a variety of servers, sub-systems, programs, modules, logs, and data stores. In particular embodiments, the inter-network facilitation system 704 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 704 may also include suitable components such as network interfaces, security mechanisms, load balancers, failover servers, management-and-network-operations consoles, other suitable components, or any suitable combination thereof. In particular embodiments, the inter-network facilitation system 704 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 704 and one or more client devices 1006. An action logger may be used to receive communications from a web server about a user's actions on or off the inter-network facilitation system 704. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 704. A privacy setting of a user determines how particular information associated with a user can be shared. The authorization server may allow users to opt into or opt out of having their actions logged by the inter-network facilitation system 704 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 704 via the network 1004. A third-party system 1008 can communicate with the inter-network facilitation system 704 to provide financial information pertaining to balances, transactions, and other information, whereupon the inter-network facilitation system 704 can provide corresponding information for display via the client device 1006. In particular embodiments, a third-party system 1008 communicates with the inter-network facilitation system 704 to update account balances, transaction histories, credit usage, and other internal information of the inter-network facilitation system 704 and/or the third-party system 1008 based on user interaction with the inter-network facilitation system 704 (e.g., via the client device 1006). Indeed, the inter-network facilitation system 704 can synchronize information across one or more third-party systems 1008 to reflect accurate account information (e.g., balances, transactions, etc.) across one or more networked systems, including instances where a transaction (e.g., a deposit) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, via a client device, a digital image comprising a digital communication;
utilizing a communication validation machine learning model to analyze the digital communication and generate a validity classification for the digital communication; and
providing a notification to the client device indicating the validity classification.

2. The method of claim 1, wherein the validity classification indicates a categorization of genuine communication or fraudulent communication.

3. The method of claim 1, wherein the validity classification indicates a certification that the digital communication originated from a specific institution.

4. The method of claim 1, wherein the validity classification of the digital communication indicates that the digital communication is fraudulent, further comprising:
utilizing the communication validation machine learning model to determine one or more indications of invalidity in the digital image;
generating instructions for addressing the digital communication based on the digital image; and
providing the one or more indications of invalidity and the instructions for addressing the digital communication in the notification to the client device.

5. The method of claim 1, further comprising:
extracting one or more user features corresponding to the client device; and
utilizing the communication validation machine learning model to further analyze the one or more user features to determine the validity classification of the digital communication.

6. The method of claim 1, further comprising:
receiving user input indicating a phone number associated with the digital communication or an email address associated with the digital communication; and
utilizing the communication validation machine learning model to further analyze the phone number associated with the digital communication or the email address associated with the digital communication to determine the validity classification of the digital communication.

7. The method of claim 1, further comprising iteratively training the communication validation machine learning model to utilizing a loss function and a ground-truth dataset of digital images of communications and corresponding ground-truth validity classifications.

8. A non-transitory computer-readable medium storing instructions that, when executed by at least one processor, cause the at least one processor to perform operations comprising:
receiving, via a client device, a digital image comprising a digital communication;
utilizing a communication validation machine learning model to analyze the digital communication and generate a validity classification for the digital communication; and
providing a notification to the client device indicating the validity classification.

9. The non-transitory computer-readable medium of claim 8, wherein the validity classification indicates a categorization of genuine communication or fraudulent communication.

10. The non-transitory computer-readable medium of claim 8, wherein the validity classification indicates a certification that the digital communication originated from a specific institution.

11. The non-transitory computer-readable medium of claim 8, wherein the validity classification of the digital communication indicates that the digital communication is fraudulent, wherein the operations further comprise:
utilizing the communication validation machine learning model to determine one or more indications of invalidity in the digital image;
generating instructions for addressing the digital communication based on the digital image; and
providing the one or more indications of invalidity and the instructions for addressing the digital communication in the notification to the client device.

12. The non-transitory computer-readable medium of claim 8, wherein the operations further comprise:
extracting one or more user features corresponding to the client device; and
utilizing the communication validation machine learning model to further analyze the one or more user features to determine the validity classification of the digital communication.

13. The non-transitory computer-readable medium of claim 8, wherein the operations further comprise:
receiving user input indicating a phone number associated with the digital communication or an email address associated with the digital communication; and
utilizing the communication validation machine learning model to further analyze the phone number associated with the digital communication or the email address associated with the digital communication to determine the validity classification of the digital communication.

14. The non-transitory computer-readable medium of claim 8, wherein the operations further comprise iteratively training the communication validation machine learning model to utilizing a loss function and a ground-truth dataset of digital images of communications and corresponding ground-truth validity classifications.

15. A system comprising:
at least one processor; and
at least one non-transitory computer-readable storage medium storing instructions that, when executed by the at least one processor, cause the system to:
receive, via a client device, a digital image comprising a digital communication;
utilize a communication validation machine learning model to analyze the digital communication and generate a validity classification for the digital communication; and
provide a notification to the client device indicating the validity classification.

16. The system of claim 15, wherein the validity classification indicates a categorization of genuine communication or fraudulent communication.

17. The system of claim 15, wherein the validity classification indicates a certification that the digital communication originated from a specific institution.

18. The system of claim 15, wherein the validity classification of the digital communication indicates that the digital communication is fraudulent, further comprising instructions that, when executed by the at least one processor, cause the system to:
utilizing the communication validation machine learning model to determine one or more indications of invalidity in the digital image;
generating instructions for addressing the digital communication based on the digital image; and
providing the one or more indications of invalidity and the instructions for addressing the digital communication in the notification to the client device.

19. The system of claim 15, further comprising instructions that, when executed by the at least one processor, cause the system to:
extracting one or more user features corresponding to the client device; and
utilizing the communication validation machine learning model to further analyze the one or more user features to determine the validity classification of the digital communication.

20. The system of claim 15, further comprising instructions that, when executed by the at least one processor, cause the system to:
receiving user input indicating a phone number associated with the digital communication or an email address associated with the digital communication; and
utilizing the communication validation machine learning model to further analyze the phone number associated with the digital communication or the email address associated with the digital communication to determine the validity classification of the digital communication.
